(19) United States
(12) Patent Application Publication
(10) Pub. No.: US 2024/0066936 A1
(43) Pub. Date: Feb. 29, 2024

(54) COIL SPRING AND SUSPENSION FOR VEHICLE

(71) Applicant: NHK SPRING CO., LTD., Yokohama-shi (JP)

(72) Inventors: Shinichi NISHIZAWA, Walled Lake, MI (US); Takeshi FURUSE, Yokohama-shi (JP); Senri MORIYAMA, Yokohama-shi (JP); Yusuke TANAKA, Yokohama-shi (JP)

(73) Assignee: NHK SPRING CO., LTD., Yokohama-shi (JP)

(21) Appl. No.: 18/494,235

(22) Filed: Oct. 25, 2023

Related U.S. Application Data
(63) Continuation-in-part of application No. 17/830,147, filed on Jun. 1, 2022, now Pat. No. 11,821,485.

(51) Int. Cl. B60G 7/04; B60G 7/00; F16F 1/12

(52) U.S. Cl. CPC B60G 7/04; B60G 7/001; F16F 1/12; B60G 2202/12

(57) ABSTRACT

A coil spring includes a wire rod including a round section portion and a flat section portion. The round section portion includes a first cross section whose cross section is round. The flat section portion includes a second cross section that is flat. The second cross section has a width greater than or equal to the diameter of the first cross section and a thickness less than the width. A polar moment of inertia of area of the second cross section is smaller than that of the first cross section. A variable section portion is formed between the round section portion and the flat section portion. The variable section portion changes its cross section from circular to flat from the round section portion towards the flat section portion.

### CROSS-REFERENCE TO RELATED APPLICATIONS

This application is a Continuation-in-Part Application of U.S. patent application Ser. No. 17/830,147, filed Jun. 1, 2022, the entire contents of which are incorporated herein by reference.

### BACKGROUND OF THE INVENTION

### 1. Field of the Invention

The present invention relates to a coil spring used, for example, in a vehicle suspension system and a suspension system for vehicle comprising the coil spring.

### 2. Description of the Related Art

An example of coil springs used in vehicle suspension devices comprises a helically-wound wire rod. In general, the cross-section of the wire rod of a coil spring (the cross-section perpendicular to the longitudinal direction of the wire rod) is round. The coil spring includes a first end turn part in contact with a first spring seat of the suspension device, a second end turn part in contacts with a second spring seat and an effective spring part between the first end turn part and the second end turn part. The effective spring part includes a plurality of coil portions. When the coil spring is compressed to a predetermined length by a load, a gap exists between the coil portions of the effective spring part. The end turn parts are in contact with the respective spring seats at all times regardless of the magnitude of the load. A part of the effective spring part is in contact with or detached away from the spring seat depending on the magnitude of the load.

The coil spring expands and contracts at a predetermined stroke between assumed minimum and maximum loads. In some vehicles, coil springs with nonlinear characteristics may be desired. Coil springs with nonlinear characteristics have a spring constant which varies in accordance with the magnitude of the load. For example, when the load is small, the coil spring deflects at a first spring constant, and when the load is large, the coil spring deflects at a second spring constant. The second spring constant is greater than the first spring constant. Tapered coil springs are also known, which include a tapered portion where the diameter of the wire rod decreases from a middle portion of the effective spring part to an end of the wire rod. In the tapered coil spring, the rigidity of the tapered portion is low, and therefore, mainly the tapered portion deflects in a range of small loads. When the load increases, the tapered portions are brought into tight contact with each other, and mainly the effective spring part deflects. As a result, nonlinear characteristics are obtained.

In the tapered coil springs described in JP S57-11743 A and U.S. Pat. No. 4,111,407, the diameter of the wire rod decreases from the middle portion of the effective spring part to the end turn part. In the tapered coil spring discussed in JP S56-141431 A, the cross sections of the wire rod in the tapered portion and the end turn part have rounded octagonal shapes close to circles. In coil springs formed of a wire red having a substantially a round section portion, it is not easy to form a portion of a wire rod with an extremely small diameter. In order to make a wire rod having a sufficiently small diameter, for example, by plastic forming, it is necessary to use a special type of rolling roll. It is possible to reduce the wire diameter by cutting or swaging, but the high processing cost and long processing time are required, and therefore these processing methods are not suitable for practical use. Due to these circumstances, it has been difficult to reduce the wire diameter of a part of the wire rods to an extremely small level.

Even if there is a limit to reducing the diameter of a wire rod of a tapered portion and a small section portion (a small diameter section) in a coil spring with nonlinear characteristics, it is still possible to reduce the spring constant in a small load range by increasing the number of turns of the tapered portion and the small section portion. The tapered portion and the small section portion of a coil spring with nonlinear characteristics are brought into tight contact with each other when the load is large. Therefore, the tapered portion and the small section portion of the coil spring, which are in tight contact with each other become a dead coil portion which does not function as a spring. Coil springs with a large number of dead coil portions cause the weight of the vehicle to increase.

In the coil springs described in JP 2000-337415 A and JP S54-52257 A, a portion of the wire rod along the length direction (a portion including the end turn parts) is rolled to form a flat portion with a flat cross section. The flat portion can be formed using an ordinary rolling roll. However, the flat portion has a much greater polar moment of inertia of area compared to a wire rod with a round section portion. For this reason, it is difficult to reduce the weight of coil springs with nonlinear characteristics, which include flat portions, even if the desired nonlinear characteristics can be obtained.

### BRIEF SUMMARY OF THE INVENTION

An object of one embodiment is to provide a light-weighted coil spring with nonlinear characteristics.

According to one embodiment of the invention, there is provided a coil spring comprising a wire rod with a first end and a second end, and including a first end turn part including the first end of the wire rod, a second end turn part including the second end of the wire rod, and an effective spring part. The effective spring part includes a plurality of coil portions formed between the first end turn part and the second end turn part and respective gaps between coil portions adjacent to each other.

The wire rod of the embodiment comprises a round section portion including a round first cross section perpendicular to a longitudinal direction of the wire rod, a flat section portion including a flat second cross section perpendicular to the longitudinal direction and a variable section portion.

The flat section portion includes a first plane and a second plane on an opposite side to the first plane. The flat section portion is formed to be one turn or more in the longitudinal direction of the wire rod from an end of the wire rod. A width of the second cross section is greater than or equal to a diameter of the first cross-section. A thickness of the second cross section is less than the width thereof. A polar moment of inertia of area of the second cross section is less than a polar moment of inertia of area of the first cross section. The variable section portion is formed between the round section portion and the flat section portion, a cross section thereof perpendicular to the longitudinal direction varies from circular to flat and an area of the cross-section decreases, from the round section portion to the flat section portion.

The flat cross section can be processed relatively easily using a rolling roll or the like. The processing of reducing the cross-sectional area of the flat section portion is easier as compared to that of the processing of reducing the cross-sectional area of the round section portion.

The polar moment of inertia of area of the flat section portion should preferably be less than 30% of the polar moment of inertia of area of the round section portion. In the coil spring of the embodiment, a width of the flat section portion may be substantially constant over a length of one or more turns of the wire rod, and a thickness of the flat section portion may be substantially constant in the longitudinal direction of the wire rod. The first end turn part should preferably include the flat section portion. The round section portion may include a plurality of coil portions which are not brought into contact with each other even when the coil spring is compressed to a maximum, and the flat section portion may include first coil portion and second coil portion that are brought into contact with each other when the coil spring is compressed.

According to the second aspect of the embodiment, a link motion type suspension device comprises a coil spring according to the embodiment. The suspension device comprises an arm member, an upper spring seat, a lower spring seat and the coil spring of the embodiment. The arm member moves in up and down directions around an axis, and inclination thereof with respect to a vehicle body varies between an upper position and a lower position. The upper spring seat is provided on the vehicle body. The lower spring seat is provided on the arm member so as to oppose the upper spring seat. In the lower spring seat, inclination thereof with respect to the upper spring seat varies as the arm member moves in the up and down directions. The coil spring includes the flat section portion and is disposed in a compressed state between the upper spring seat and the lower spring seat.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a coil spring according to the first embodiment.

FIG. 2 is a perspective view of a portion of the coil spring shown in FIG. 1, including cross sections of the coil spring in a compressed state.

FIG. 3 is a side view of a portion of a wire rod of the coil spring before coiling.

FIG. 4 is a cross-sectional view schematically showing an example of a quadrangle section portion of the wire rod.

FIG. 5 is a diagram showing a polar moment of inertia of area of each of four types of wire rods with different cross-sections.

FIG. 6 is a diagram schematically showing spring characteristics (a relationship between deflection and load) of the coil spring shown in FIG. 1.

FIG. 7 is a diagram showing a relationship between a position from a lower end (turns from the lower end) and stress (inner side of coil) of the coil spring.

FIG. 8 is a perspective view schematically showing a rolling machine.

FIG. 9 is a plan view of a portion of the coiling machine.

FIG. 10 is a perspective view of a coil spring according to the second embodiment.

FIG. 11 is a perspective view of a coil spring according to the third embodiment.

FIG. 12 is a perspective view shown by a cross section of a part of the coil spring shown in FIG. 11.

FIG. 13 is a side view showing a wire rod before the coil spring shown in FIG. 11 is coiled.

FIG. 14 is a cross-sectional view of a round section portion taken along line F14-F14 in FIG. 13.

FIG. 15 is a cross-sectional view of a variable section portion taken along line F15-F15 in FIG. 13.

FIG. 16 is a cross-sectional view of a flat section portion taken along line F16-F16 in FIG. 13.

FIG. 17 is a side view of a link motion type suspension device including the coil spring shown in FIG. 11 partially by cross-section.

### DETAILED DESCRIPTION OF THE INVENTION

### First Embodiment

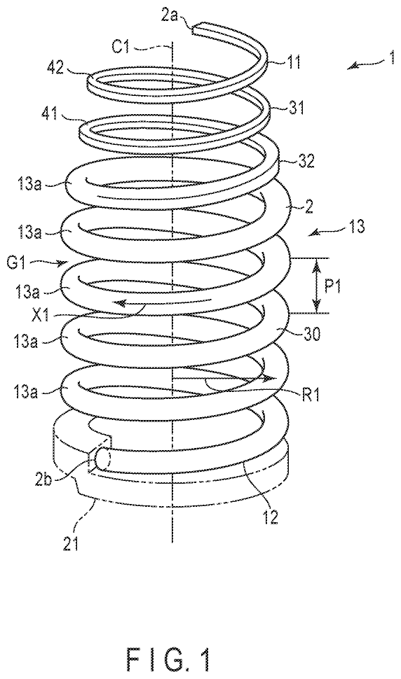

A coil spring according to the first embodiment will now be described with reference to FIGS. 1 to 9.

FIG. 1 shows a coil spring 1 used in a suspension device of a vehicle such as an automobile. The coil spring 1 includes a wire rod 2 wound in a spiral shape. The wire rod 2 is made of spring steel, for example, and has a first end 2a and a second end 2b. The coil spring 1 has a first end turn part 11 including the first end 2a of the wire rod 2, a second end turn part 12 including the second end 2b and an effective spring part 13.

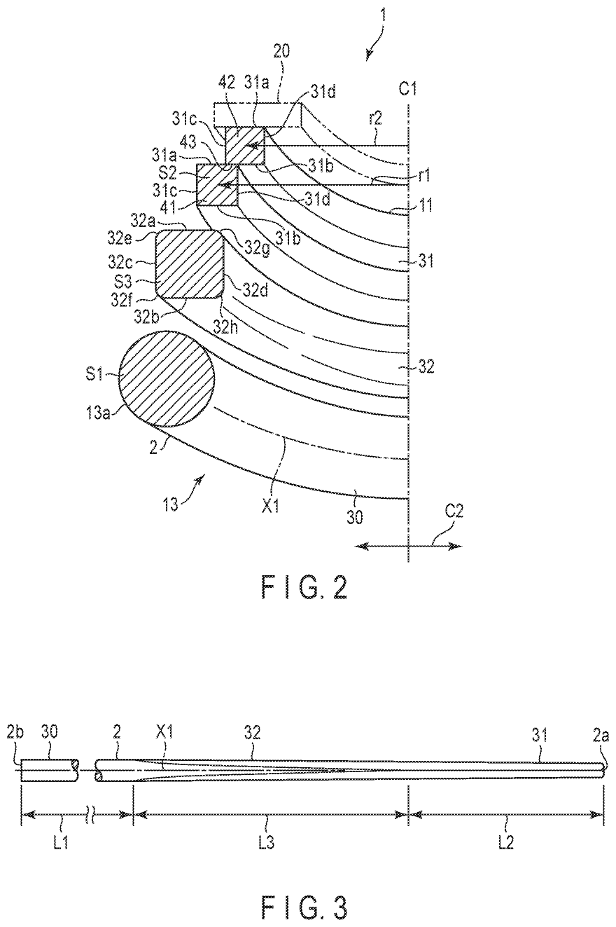

The effective spring part 13 is formed between the first end turn part 11 and the second end turn part 12 and includes a plurality of coil portions 13a. When the coil spring 1 is assembled into a vehicle suspension system, the first end turn part 11 including the first end 2a is located on an upper side and the second end turn part 12 including the second end 2b is located on a lower side. In this case, a central axis C1 of the coil spring 1 extends along up and down directions. The direction perpendicular to the central axis C1 (indicated in FIG. 2 with an arrow C2 pointing both directions) is a radial direction of the coil spring 1.

For example, the effective spring part 13 has a cylindrical shape with a constant pitch P1 (shown in FIG. 1) and a coil diameter R1 which is substantially constant. Here, the expression “substantially constant” is meant such a degree that the variation is within the tolerance range of the coil spring manufactured by the coiling machine, or the variation in the tolerance range due to springback is negligible in practical use. Note that such a non-cylindrical coil spring may as well do that the pitch P1 and the coil diameter R1 vary in a direction along the central axis C1.

The first end turn part 11 is supported by a spring seat 20 (shown in FIG. 2) on an upper side of the suspension system. The second end turn part 12 is supported by a lower spring seat 21 (shown in FIG. 1) on a lower side of the suspension system. The coil spring 1 is compressed between the upper spring seat 20 and the lower spring seat 21. While the coil spring 1 is compressed in a predetermined load range (the range of load used as a suspension system), the effective spring part 13 has a gap G1 between each adjacent pair of coil portions 13a.

The coil spring 1 employed in a vehicle suspension system is used in a load range between assumed minimum and maximum loads. In the effective spring part 13, adjacent coil portions 13a are not brought into contact with each other between a full bump state where the spring is compressed at maximum and a full rebound state where it is expanded at maximum, and therefore, functions effectively as a spring.

FIG. 2 is a perspective view of the coil spring 1, including cross sections of parts of the coil spring 1 (near the end turn parts 11) in a compressed state. The coil spring 1 of this embodiment includes a round section portion 30, a quadrangle section portion 31, and a variable section portion 32. The variable section portion 32 is formed between the round section portion 30 and the quadrangle section portion 31. The first end turn part 11 includes the quadrangle section portion 31 and is formed into a spiral shape. The second end turn part 12 includes a part of the round section portion 30 and is formed into a spiral shape. The effective spring part 13 comprises the round section portion 30 and a plurality of coil portions 13a formed into a spiral shape.

FIG. 3 shows a part of the wire rod 2 before it is coiled. An axis X1 passing through the center of wire rod 2 extends in the length direction of the wire rod 2. The wire rod 2 shown in FIG. 3 includes a round section portion 30 having a length L1, a quadrangle section portion 31 having a length L2, and a variable section portion 32 having a length L3.

The round section portion 30 has the length L1 necessary for the multiple coil portions 13a of the effective spring part 13. The quadrangle section portion 31 is formed over the length L2 from the first end 2a of the wire rod 2. The length L2 is equivalent to two or more turns of the coil spring 1 formed in a spiral shape. The variable section portion 32 is formed between the round section portion 30 and the quadrangle section portion 31 over the length L3. The quadrangle section portion 31 has the length L2 from the first end 2a over the first end turn part 11 and includes at least a first coil portion 41 and a second coil portion 42.

As shown in FIG. 2, the round section portion 30 includes a first cross-section S1 perpendicular to the axis X1 of the wire rod 2. The first cross-section S1 is circular. The first cross-section S1 is substantially constant in the length direction (along the axis X1) of the wire rod 2. The second end turn part 12 is a part of the round section portion 30, and therefore the cross-section of the wire rod 2 is circular. The diameter of the wire rod in the second end turn part 12 (the diameter of the cross-section of the wire rod 2) is the same as the diameter of the wire rod in the effective spring part 13.

The quadrangle section portion 31 includes a quadrangle second cross section S2 perpendicular to the axis X1 of the wire rod 2. The quadrangle section portion 31 includes a first plane 31a on an upper side, a second plane 31b on a lower side, a third plane 31c on an outer side and a fourth plane 31d on an inner side. The first plane 31a and the second plane 31b are each arranged along the radial direction of the coil spring 1 (indicated by arrows C2 in both directions in FIG. 2). The third plane 31c and the fourth plane 31d are each along the central axis C1 of the coil spring 1.

FIG. 2 shows the state of the coil spring 1 compressed by the load along the central axis C1. The quadrangle section portion 31 has a first coil portion 41 and a second coil portion 42. The coil diameter r2 of the second coil portion 42 is smaller than or the same as the coil diameter r1 of the first coil portion 41. When the coil spring 1 is compressed, the first plane 31a of the first coil portion 41 and the second plane 31b of the second coil portion 42 are overlaid on each other in a direction along the central axis 1C of the coil spring 1. Thus, a contact portion 43 is formed where the first coil portion 41 and the second coil portion 42 are brought into contact with each other along the thickness direction. With this structure, it is possible to avoid the second coil portion 42 from entering (slipping into) an inner side of the first coil portion 41.

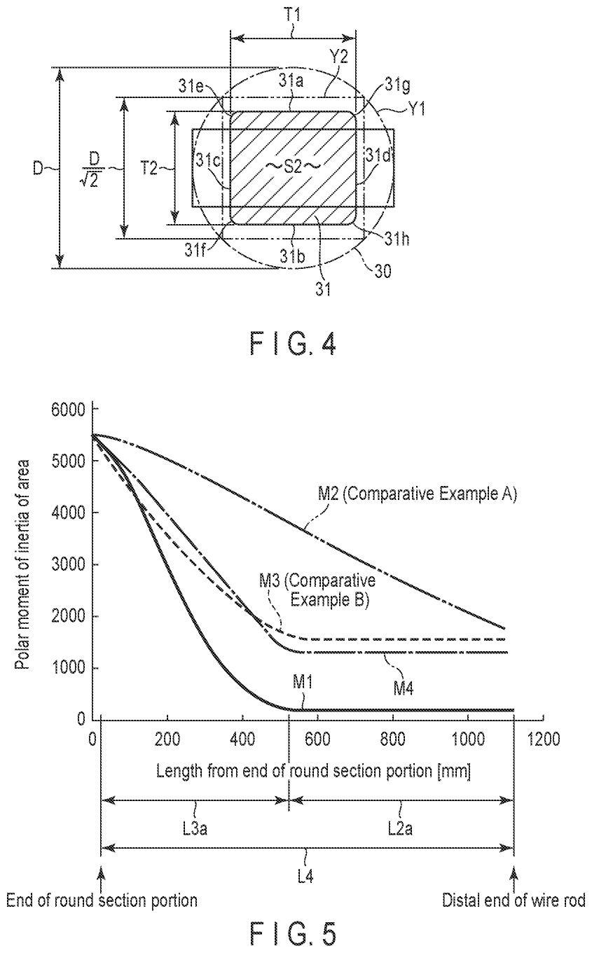

FIG. 4 shows a cross-sectional view schematically showing an example of the quadrangle section portion 31. The second cross section S2 is a quadrangle including a square or rectangle. In FIG. 4, a width of each of the first plane 31a and the second plane 31 b is represented by T1. A thicknesses of each of the third plane 31c and the fourth plane 31d is represented by T2. The cross-section of the quadrangle section portion 31 (the second cross section S2) is substantially constant in the length direction of the wire rod 2 (along the axis X1).

As shown in FIG. 4, the width T1 and the thickness T2 of the second cross-section S2 are each less than a diameter D of the first cross section S1. The area of the second cross section S2 is represented as the product of T1 and T2, that is, (T1·T2). A one-dotted chain line provided in FIG. 4 represents a circle Y1 having a diameter D. The circle Y1 corresponds to a contour of an outer circumferential surface of the wire rod 2. A two-dotted chain line in FIG. 4 represents a right square Y2 inscribed in the circle Y1. The cross-sectional area of the quadrangle section portion 31, that is, the area of the second cross section S2, is smaller than the area of the square Y2 inscribed in the circle Y1. In other words, there are relationships of T1<D, T2<D, and T1·T2<D²/2.

The width T1 of the cross section of the quadrangle section portion 31 may be greater than the thickness T2. In this case, the contact area of the contact portion 43 can be made larger as compared to the cross section of the square. When the width T1 is greater than the thickness T2, the rigidity of the coil along its radial direction (indicated in FIG. 2 by the arrow C2) can be increased compared to the end turn part made of a wire rod having a round section portion. Here, note that the width T1 and thickness T2 may be the same as each other. The width T1 and the thickness T2 each should preferably be less than or equal to a ½ of square root (1/√2) of the diameter D of the first cross section.

The angle between the first plane 31a and the third plane 31c may be, for example, 90°. The angle between the first plane 31a and the fourth plane 31d is, for example, 90°. The angle between the second plane 31b and the third plane 31c is, for example, 90°. The angle between the second plane 31b and the fourth plane 31d is, for example, 90°.

Between the first plane 31a and the third plane 31c, a rounded first corner portion 31e may be formed. Between the second plane 31b and the third plane 31c, a rounded second corner portion 31f may be formed. Between the first plane 31a and the fourth plane 31d, a rounded third corner portion 31g may be formed. Between the second plane 31b and the fourth plane 31d, a rounded fourth corner portion 31h may be formed.

The cross-section of the variable section portion 32 (the third cross-sectional section S3 perpendicular to the axis X1) gradually changes from circular to quadrangle and decreases its cross-sectional area from the round section portion 30 to the quadrangle section portion 31. The variable section portion 32 is formed between the round section portion 30 and the quadrangle section portion 31 by 1.0 turn or more.

As shown in FIG. 2, the cross-section (the third cross section S3) of the variable section portion 32 includes a first surface 32a, a second surface 32b, a third surface 32c and a fourth surface 32d. Between the first surface 32a and the third surface 32c, a first arc portion 32e is formed. A second arc portion 32f is formed between the second surface 32b and the third surface 32c. A third arc portion 32g is formed between the first surface 32a and the fourth surface 32d. A fourth arc portion 32h is formed between the second surface 32b and the fourth surface 32d.

The first surface 32a is continuous to the first plane 31a of the quadrangle section portion 31. The second surface 32b is continuous to the second plane 31b. The third surface 32c is continuous to the third plane 31c. The fourth surface 32d is continuous to the fourth plane 31d. The first surface 32a and the second surface 32b are arranged along the radial direction of the coil spring 1 (indicated by arrow C2 in both directions in FIG. 2). The third surface 32c and the fourth surface 32d are arranged along the central axis C1 of the coil spring 1.

The first arcuate portion 32e is continuous to the first corner portion 31e of the quadrangle section portion 31 (shown in FIG. 4). The second arc section 32f is continuous to the second corner section 31f of the quadrangle section portion 31. The third arc portion 32g is continuous to the third corner portion 31g of the quadrangle section portion 31. The fourth arc portion 32h is continuous to the fourth corner portion 31h of the quadrangle section portion 31.

FIG. 5 is a diagram showing the relationship between the longitudinal position and the polar moment of inertia of area (torsional rigidity) for three types of wire rods whose cross-sections are different from each other. A solid line M1 in FIG. 5 represents the polar moment of inertia of area of the wire rod 2 having a quadrangle section portion 31. The wire rod diameter of the round section portion 30 is 15.4 mm, and each of the width T1 and the thickness T2 of the quadrangle section portion 31 is about 6 mm. In FIG. 5, the horizontal axis from zero (0) to the length L3a indicates the polar moment of inertia of area of the variable section portion 32, and the length L2a indicates the polar moment of inertia of area of the quadrangle section portion 31. The polar moment of inertia of area of the quadrangle section portion 31 is sufficiently small compared to the polar moment of inertia of area of the round section portion 30.

A two-pointed line M2 in FIG. 5 indicates the polar moment of inertia of area of a wire rod of Comparative Example A, which includes a flat taper portion. The wire rod in Comparative Example A has a wire rod diameter of 15.4 mm in the round section portion. Over a length L4, from an end of the round section portion to the distal end of the wire rod, the flat taper portion is formed. The cross-section of the flat tapered section (the cross-section perpendicular to the wire rod along the length direction) is a flat rectangle. The width of the end surface of the flat tapered portion is 15.4 mm or greater and the thickness thereof is 5.5 mm.

The polar moment of inertia of area (two-point chain line M2) of Comparative Example A, which includes a flat tapered section is much greater than the polar moment of inertia of area (solid line M1) of the wire rod 2 including the quadrangle section portion 31. In the case of the coil spring made of the wire rod of Comparative Example A, it is necessary to increase the number of turns in the flat tapered portion to reduce the first spring constant when the spring deflects in the small load range. Therefore, when the coil spring of Comparative Example A deflects at the second spring constant (large load range), the number of coil portions of the dead coil portion which does not function as a spring increases, and the weight thereof increases accordingly.

A dashed line M3 in FIG. 5 indicates the polar moment of inertia of area of a wire rod in Comparative Example B, which includes a round taper portion. The wire rod of Comparative Example B includes a round taper portion having a length L3a from the end of the round section portion and a small section portion having a length L2a (a wire rod diameter of 11.4 mm). The wire rod diameter of the round section portion is 15.4 mm. The polar moment of inertia of area (the dashed line M3) of Comparative Example B is greater than the polar moment of inertia of area (the solid line M1) of the wire rod 2 including a quadrangle section portion 31. In the case of the coil spring made of the wire rod of Comparative Example B, it is necessary to increase the number of turns in the round tapered portion in order to reduce the first spring constant when the spring deflects in the small load range. Therefore, when the spring deflects at the second spring constant (large load range), the number of turns in the dead coil portion part, which does not function as a spring, increases, and the weight thereof increases accordingly. Moreover, it is not easy to form a round tapered section by processing a wire rod with a round cross section. In contrast, the quadrangle section portion 31 can be processed relatively easily using at least one pair of rolling rolls.

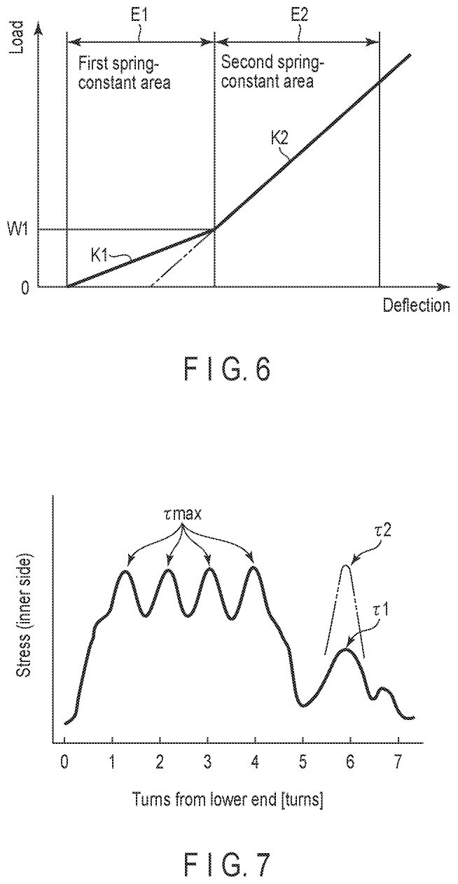

FIG. 6 is a diagram schematically showing spring characteristics (a relationship between the load and deflection) of the coil spring 1 including the quadrangle section portion 31. In FIG. 6, the horizontal axis indicates deflection and the vertical axis indicates the load. The coil spring 1 is compressed between the spring seat 21 (shown in FIG. 1) on an lower side and the spring seat 20 (shown in FIG. 2) on an upper side. Between the load is zero and W1, the quadrangle section portion 31 mainly deflects. Therefore, as shown by line K1 in FIG. 6, it results in a first spring constant region E1 with a relatively small spring constant. When the load exceeds W1, the quadrangle section portion 31 is in a state of tight contact and mainly the round section portion 30 deflects. Therefore, as shown by line K2 in FIG. 6, the spring constant increases (a second spring constant range E2).

FIG. 7 shows the relationship between the stress generated on an inner side of the wire rod when the coil spring 1 is compressed and the position from the lower end of the wire rod 2 (turns from the lower end). A peak τmax of stress is generated in each of the coil portions 13a of the effective spring part 13. These peaks τmax are smaller than the stress tolerable in the suspension system. A small peak T1 occurs near the end turn parts 11. The inventor has made a careful study and found that when the number of coil portions of the variable section portion 32 is less than 1.0, as indicated by T2 in FIG. 7, the stress in the variable section portion 32 exceeds the peak τmax of the stress in the effective spring part 13, as indicated by T2 in FIG. 7. It is undesirable for the stress in the variable section portion 32 to exceed the stress in the effective spring part 13. Therefore, in this study, the number of coil portions of the variable section portion 32 was set to 1.0 or more.

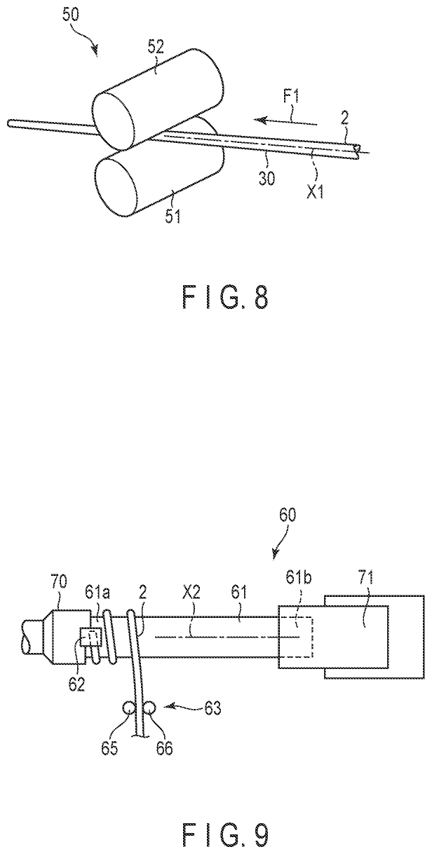

FIG. 8 schematically shows an example of a rolling apparatus 50 for forming a quadrangle section portion 31 and a variable section portion 32. The wire rod 2 having a round cross section moves in the direction indicated by arrow F1. The rolling apparatus 50 includes rolling rolls 51 and 52. The distance between the rolling rolls 51, 52 can be adjusted. The wire rod 2 is rolled as the wire rod 2 passes through the rolling rolls 51 and 52. The wire rod 2 is then rotated 90° around the axis X1, and the wire rod 2 is rolled again by the rolling rolls 51 and 52.

FIG. 9 shows a part of a coiling machine 60 which forms coil springs by hot rolling (for example, at an A3 transformation point or higher but 1150° C. or less). The coiling machine 60 includes a cylindrical mandrel 61, a chuck 62 and a guide portion 63. The guide portion 63 includes a pair of first guide rolls 65 and 66.

The wire rod 2, made of spring steel, is pre-cut to a length equivalent to one coil spring. The wire rod 2 is heated to an austenitization temperature (at an A3 transformation point or higher but 1150° C. or less) and fed by a feeding mechanism to the mandrel 61. The chuck 62 secures the distal end of the wire rod 2 to the mandrel 61. The guide portion 63 guides the wire rod 2 to control the position thereof as it is wound onto the mandrel 61. One end portion 61a of the mandrel 61 is held by the chuck 62 to a drive head 70. The mandrel 61 is rotated around an axis X2 of the mandrel 61 by the drive head 70. The other end 61b of the mandrel 61 is rotatably supported by a mandrel holder 71. The guide portion 63 moves along the axis X2 of the mandrel 61 and guides the wire rods 2 according to the pitch angle of the coil spring to be formed.

The wire rod 2 has a length equivalent to one coil spring. Before the wire rod 2 is fed to the mandrel 61, the wire rod 2 is heated by a furnace. The distal end of the heated wire rod 2 is fixed to the mandrel 61 by the chuck 62. As the mandrel 61 rotates, and in synchronization with the rotation of mandrel 61, the guide portion 63 moves in a direction along the axis X2 of the mandrel 61. As a result, the wire rods 2 are wound onto the mandrel 61 at a predetermined pitch.

Comparative Examples 1, 2, 3 and 4, provide below, are each directed to a coil spring with nonlinear characteristics, including an effective spring part including a round section portion, a round tapered portion and a small section portion. By contrast, Examples 1, 2, 3 and 4 are each directed to a coil spring with nonlinear characteristics, similar to the coil spring 1 shown in FIG. 1, including a round section portion 30, a quadrangle section portion 31 and a variable section portion 32.

### Comparative Example 1

The coil spring of Comparative Example 1 has a wire rod diameter of 18 mm in the round section portion part, a wire rod diameter of 13 mm in the small section portion, a total number of coils of 8.5, and a weight of 7.0 kg.

### Example 1

The coil spring of Example 1 has a wire rod diameter of 18 mm in the round section portion 30, a width and a thickness of the cross section (the second cross section) of the quadrangle section portion 31 of about 7 mm in each and a total number of coils of 8.5. The spring characteristics (the relationship between the load and deflection) of Example 1 are similar to those of Comparative Example 1. The weight of the coil spring of Example 1 is 5.2 kg, which is about 24% lighter than that of the coil spring of Comparative Example 1.

### Comparative Example 2

The coil spring of Comparative Example 2 has a wire rod diameter of 15 mm in the round section portion, a wire rod diameter of 11 mm in the small section portion, a total number of coils of 8.5, and a weight of 7.0 kg.

### Example 2

The coil spring of Example 2 has a wire rod diameter of 15 mm in the round section portion 30, a width and a thickness of the cross section (the second cross section) of the quadrangle section portion 31 of about 7 mm in each and a total number of coils of 9.0. The spring characteristics of Example 2 are similar to those of Comparative Example 2. The weight of the coil spring of Example 2 is 4.0 kg, which is about 23% lighter than that of the coil spring of Comparative Example 2.

### Comparison Example 3

The coil spring of Comparative Example 3 has a wire rod diameter of 22 mm in the round section portion, a wire rod diameter of 17 mm in the small section portion, a total number of coils of 8.0, and a weight of 8.5 kg.

### Example 3

The coil spring of Example 3 has a wire rod diameter of 22 mm in the round section portion 30, a width and a thickness of the cross section (the second cross section) of the quadrangle section portion 31 of about 7 mm in each and a total number of coils of 8.0. The spring characteristics of Example 3 are similar to those of Comparative Example 3. The weight of the coil spring of Example 3 is 6.5 kg, which is about 22% lighter than that of the coil spring of Comparative Example 3.

### Comparative Example 4

The coil spring of Comparative Example 4 has a wire rod diameter of 16 mm in the round section portion, a wire rod diameter of 12 mm in the small section portion, a total number of coils of 10.0, and a weight of 6.0 kg.

### Example 4

The coil spring of Example 4 has a wire rod diameter of 15 mm in the round section portion 30, a width and a thickness of the cross section (the second cross section) of the quadrangle section portion 31 of about 7 mm in each and a total number of coils of 9.0. The spring characteristics of Example 4 are similar to those of Comparative Example 4. The weight of the coil spring of Example 4 is 5.0 kg, which is about 18% lighter than that of the coil spring of Comparative Example 4.

The quadrangle section portion 31 can be formed by rolling rolls. However, due to shape errors which may occur during the forming process, the width and thickness of the second cross section S2 may vary. Here, the width and thickness of the second cross section S2 are each made less than the wire rod diameter (the diameter of the first cross section S1), and the area of the second cross section S2 is made less than the area of the square inscribed in the circle of the diameter of the first cross section S1. Thus, the weight of the spring can be reduced compared to conventional coil springs. In particular, when the width T1 and the thickness T2 of the quadrangle section portion 31 are each less than or equal to a ½ of square root (1/√2) of the diameter D of the first cross section S1, the weight reduction ratio is significant.

### Second Embodiment

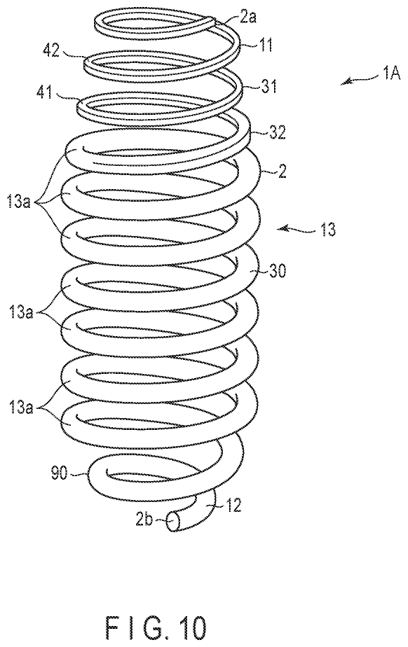

FIG. 10 shows a coil spring 1A according to the second embodiment. The coil spring 1A includes a quadrangle section portion section 31 having two or more turns, and a variable section portion 32 having 1.0 or more turns. The cross-section of the wire rod of the second end turn part 12 is circular, and the wire rod diameter is the same as the wire rod diameter of the round section portion 30. The second end turn part 12 includes a small diameter coil portion 90 whose coil diameter decreases toward the second end 2b of the wire rod 2. The wire rod diameter of the second end turn part 12 may be less than the wire rod diameter of the round section portion 30. Since the coil spring 1A of the second embodiment has a configuration and action common with those as the coil spring 1 of the first embodiment, except for those mentioned above, the same reference symbols are attached to the common structural members, and the descriptions thereof will be omitted.

### Third Embodiment

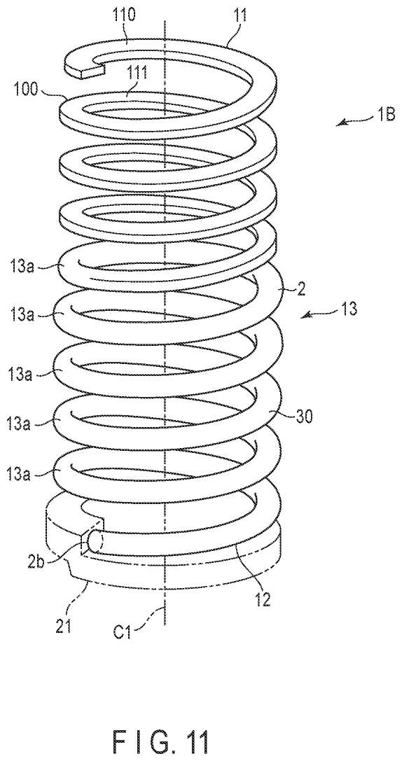

A coil spring 1B according to the third embodiment will now be described with reference to FIGS. 11 to 16.

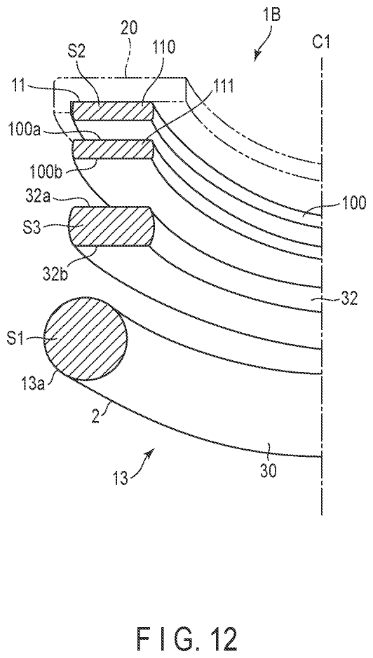

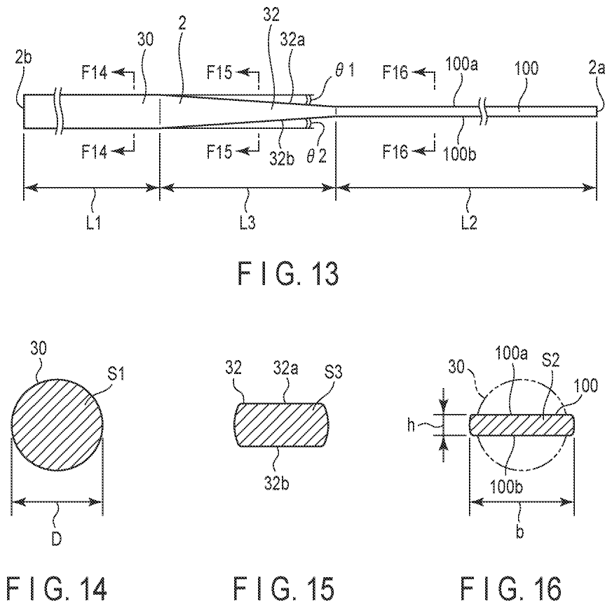

FIG. 11 is a perspective view of the coil spring 1B, and FIG. 12 is a perspective view of the coil spring 1B partially by cross section. FIG. 13 is a side view of a wire rod 2 before the coil spring 1B is coiled. The wire rod 2 includes a round section portion 30, a variable section portion 32 and a flat section portion 100. FIG. 14 shows a cross-section of the round section portion 30. FIG. 15 shows a cross-section of the variable section portion. FIG. 16 shows a cross-section of the flat section portion 100. With respect to the coil spring 1B, the parts common to those of the coil spring 1 of the first embodiment are designated by reference symbols common to those of the coil spring 1 of the first embodiment. Hereinafter, the flat section portion 100 will be mainly explained.

FIG. 16 shows a cross-section (second cross-section S2) of the flat section portion 100. The flat section portion 100 includes a first plane 100a and a second plane 100b on an opposite side to the first plane 100a. The first plane 100a and the second plane 100b are substantially parallel to each other and extend in a radial direction of the coil spring 1B. In this specification, the expression “substantially parallel to each other” is of a concept that allows for variations caused by reasons unintended by the manufacturer, such as forming errors or tolerances that inevitably occur when the wire rod 2 is rolled.

As shown in FIG. 16, if the width of the flat section portion 100 is defined as b and the thickness is defined as h, the polar moment of inertia of area IP of the flat section portion 100 can be obtained by: IP=bh(h²+b²)/12. The width b of the flat section portion 100 is the same as or larger than the diameter D of the round section portion 30. The thickness h of the flat section portion 100 is substantially constant in the length direction of the wire rod 2 over one or more turns of the coil spring 1B. The width b is greater than the thickness h. The width b is the width of the wire rod of the coil spring 1B in the radial direction. The thickness h is the thickness of the wire rod of the coil spring 1B in the length direction.

As shown in FIG. 13, the round section portion 30 has a first length L1. The flat section portion 100 has a second length L2. The second length L2 is equal to or more than one turn of the coil spring 1B from an end 2a thereof and includes an end turn part 11. The variable section portion 32 is formed between the round section portion 30 and the flat section portion 100. The variable section portion 32 has a third length L3. The length (second length L2) of the flat section portion 100 is greater than the length L3 (third length L3) of the variable section portion 32.

As shown in FIG. 13, the first surface 32a of the variable section portion 32 decreases in thickness at a first angle θ1 toward the first plane 100a of the flat section portion 100. The second surface 32b of the variable section portion 32 decreases in thickness at a second angle θ2 toward the second plane 100b of the flat section portion 100. The first angle θ1 and the second angle θ2 are substantially equal to each other. The term “substantially equal angles” as used in this specification is of a concept that allows for variations caused by reasons unintended by the manufacturer, such as forming errors or tolerances that inevitably occur when the wire rod 2 is rolled.

The flat section portion 100 has a substantially constant width b (shown in FIG. 16) over the second length L2. The thickness h of the flat section portion 100 is substantially constant over the second length L2. The term “substantially constant” as used in this specification is of a concept that allows for variations caused by reasons unintended by the manufacturer, such as forming errors or tolerances that inevitably occur when rolling the wire rod 2. As shown in FIGS. 11 and 12, the flat section portion 100 includes a first coil portion 110 and a second coil portion 111. The first coil portion 110 and the second coil portion 111 may be brought into contact with each other while the coil spring 10B is compressed.

FIG. 14 shows a cross-section (first cross-section S1) of the round section portion 30. As shown in FIG. 14, when the diameter of the first cross-section S1 is defined as D, the polar moment of inertia of area IP of the first cross-section S1 can be obtained by: IP=πD⁴/32.

The flat section portion 100 can be formed by rolling a longitudinal part of the wire rod 2. If the cross-sectional area of the flat section portion 100 is the same as that of the round section portion 30, the polar moment of inertia of area of the flat section portion 100 is larger than that of the round section portion 30.

For example, when the diameter D of the round section portion 30 is 15.4 mm, the cross-sectional area of the first cross section S1 is 186.2 mm² and the polar moment of inertia of area is 5519 mm⁴. When the cross-sectional area of the flat cross section (second cross section S2) is the same as that of the first cross section S1, a flat cross section, in one example, has a thickness of 10 mm and a width of 18.62 mm. The polar moment of inertia of area thereof is 6913 mm⁴, which is 125% of the polar moment of inertia of area of the round section portion 30. Therefore, the torsional rigidity of the flat section portion is greater than that of the round section portion 30. Such a coil spring is not in accordance with the object of the embodiment.

The polar moment of inertia of area M3 of the small-diameter cross-sectional section (φ1.4 mm) of Comparative Example B shown in FIG. 5 is 1657.3 mm⁴. Since the polar moment of inertia of area of the round section portion (05.4 mm) is 5519.0 mm⁴, the polar moment of inertia of area M3 of the small diameter cross-sectional section of Comparative Example B is 30.03% of the polar moment of inertia of area of the round section portion. In order to make the torsional rigidity of the flat section portion 100 smaller than that of Comparative Example B, the polar moment of inertia of area of the flat section portion 100 need to be made smaller than the polar moment of inertia of area M3 of Comparative Example B. In other words, the polar moment of inertia of area of the flat section portion 100 should be less than 30% of the polar moment of inertia of area of the round section portion 30.

In one example of the flat section portion 100 shown in FIG. 16 has a width b of 15.4 mm and a thickness h of 4.5 mm. The polar moment of inertia of area of the flat section portion 100 (indicated by a one-point chain line M4 in FIG. 5) is 1486.5 mm⁴, which is 26.9% of the polar moment of inertia of area of the round section portion 30 (5519 mm⁴). In another example, the flat section portion 100 has a width b of 15.4 mm and a thickness h of 4.8 mm. The polar moment of inertia of area of the flat section portion 100 is 1602.8 mm⁴, which is 29.04% of the polar moment of inertia of area of the round section portion 30 (5519 mm⁴). As illustrated in these examples, the polar moment of inertia of area of the flat section portion 100 should be less than 30.0% of the polar moment of inertia of area of the round section portion 30.

The end portion of the coil spring 1B of this embodiment is constituted by a flat section portion 100. The width b (width of the wire rod of radial direction of the coil spring) of the flat section portion 100 is greater than the thickness h (thickness of the wire rod of longitudinal direction of the coil spring). The end portion of the coil spring 1B includes the flat section portion 100. The flat section portion 100 having a thickness h has a rigidity in the coil radial direction greater than that of the cross section of a square with one side having a thickness h. With this structure, it is possible to suppress the coil spring 1B from being deforming in the radial direction of the coil, such as bowing or the like. For example, when the coil spring 1B is compressed, deformation of the end portion (near the end turn part 11) of the coil spring 1B in the coil radial direction can be suppressed.

### Fourth Embodiment

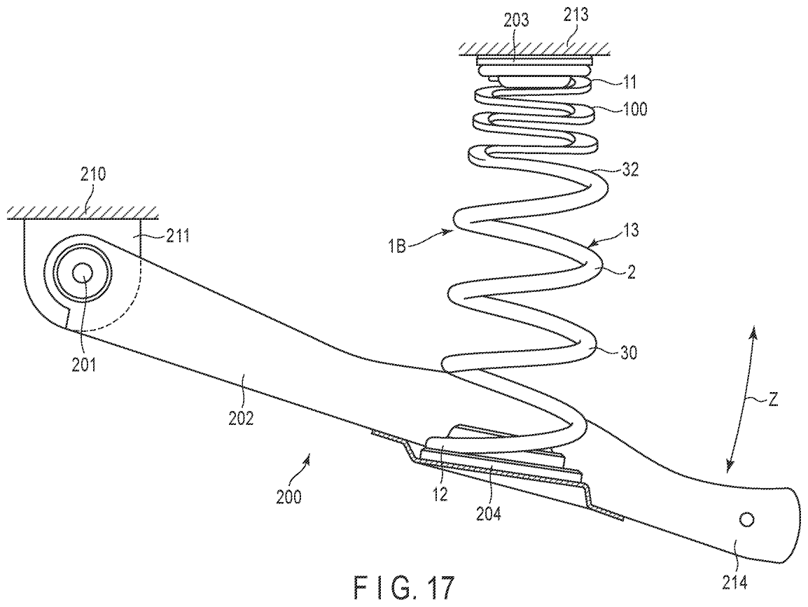

FIG. 17 is a side view showing a part of a link motion type suspension device 200. The suspension device 200 includes a coil spring 1B shown in FIG. 11. In one example, the link motion type suspension device 200 includes an arm member 202 that moves around an axis 201 in up and down directions, a coil spring 1B, an upper spring seat 203 and a lower spring seat 204. The arm member 202 changes its inclination with respect to the vehicle body between the upper position and the lower position. The upper spring seat 203 supports a first end turn part 11 of the coil spring 1B. The lower spring seat 204 supports a second end turn part 12 of the coil spring 1B.

In one example, the axis 201 that supports the arm member 202 is a pivot axis provided in the arm mount portion 211 of a vehicle body 210, which may as well be an axial structure other than a pivot axis. Depending on the specifications of the suspension device, it may as well be of a multi-link type, which includes multiple arm members and multiple axes. The upper spring seat 203 is located in a part 213 of the vehicle body. The lower spring seat 204 is provided on the arm member 202 between the axis 201 and the axle support portion 214.

When the arm member 202 moves in the up and down directions, the lower spring seat 204 moves in the up and down directions. When the lower spring seat 204 moves in the up and down directions, the inclination of the lower spring seat 204 with respect to the upper spring seat 203 varies. The coil spring 1B is placed in a compressed state between the upper spring seat 203 and the lower spring seat 204.

The suspension device 200 shown in FIG. 17 has a coil spring 1B similar to that of the third embodiment (FIGS. 11 to 16). As described above, the wire rod 2 of the coil spring 1B includes a round section portion 30, a variable section portion 32 and a flat section portion 100 turned one time or more. The polar moment of inertia of area of the flat section portion 100 is smaller than the polar moment of inertia of area of the round section portion 30. It is preferable that the polar moment of inertia of area of the flat section portion 100 be less than 30% of the polar moment of inertia of area of the round section portion 30.

As indicated by the bidirectional arrow Z shown in FIG. 17, when the arm member 202 moves in the up and down directions, the length of the coil spring 1B (amount of compression) changes according to the height of the lower spring seat 204. Further, the inclination of the lower spring seat 204 with relative to the upper spring seat 203 varies. Thus, the coil spring 1B used in the link motion type suspension device is not compressed parallel. As the coil spring 1B is compressed to shorten its length, the relative inclination of the lower spring seat 204 increases. Therefore, a force in a coil radial direction (a lateral force) may act on the end portion of the coil spring 1B (near the end turn part 11). The lateral force is applied in the bending (buckling) direction of the coil spring 1B, and therefore caution is required.

The end portion (near the end turn part 11) of the coil spring 1B of this embodiment includes a flat section portion 100. By making the width b of the wire rod in the coil radial direction (shown in FIG. 16) of the end portion of the coil spring 1B slightly larger than the diameter D of the cross section of the round section portion 30 (shown in FIG. 14), the rigidity along the coil radial direction can be increased. With this structure, it is possible to prevent the end portion of the coil spring 1B from being bent in the coil radial direction. Thus, the suspension device 200 with the coil spring 1B of this embodiment may be able to suppress buckling of the coil spring 1B when it is in a compressed state.

The coil spring of the embodiment may be applied as a suspension spring for various types of forms of suspension devices such as the link motion type. The coil spring of this embodiment may be applied to suspension devices other than those of vehicles.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A coil spring comprising a wire rod with a first end and a second end and including a first end turn part including the first end of the wire rod, a second end turn part including the second end of the wire rod, and an effective spring part including a plurality of coil portions formed between the first end turn part and the second end turn part, with respective gaps between coil portions adjacent to each other,
the wire rod comprising:
a round section portion including a round first cross section perpendicular to a longitudinal direction of the wire rod;
a flat section portion including a flat second cross section perpendicular to the longitudinal direction, and including a first plane and a second plane on an opposite side to the first plane, formed to be one turn or more in the longitudinal direction of the wire rod, a width of the second cross section being greater than or equal to a diameter of the first cross section, and a polar moment of inertia of area of the second cross section being less than a polar moment of inertia of area of the first cross section; and
a variable section portion formed between the round section portion and the flat section portion of the wire rod, a cross section thereof perpendicular to the longitudinal direction varying from circular to flat and an area of the cross-section decreasing, from the round section portion to the flat section portion.

2. The coil spring according to claim 1, wherein
the polar moment of inertia of area of the flat section portion is less than 30% of the polar moment of inertia of area of the round section portion.

3. The coil spring according to claim 1, wherein
a width of the flat section portion is substantially constant over a length of one or more turns of the wire rod, and a thickness of the flat section portion is substantially constant in the longitudinal direction of the wire rod.

4. The coil spring according to claim 1, wherein
the first end turn part includes the flat section portion.

5. The coil spring according to claim 1, wherein
the round section portion has a plurality of coil portions which are not brought into contact with each other even when the coil spring is compressed to a maximum, and
the flat section portion includes first coil portion and second coil portion that are brought into contact with each other when the coil spring is compressed.

6. A link motion type suspension device comprising a coil spring according to claim 1, the device comprising:
an arm member which moves in up and down directions around an axis, inclination thereof with respect to a vehicle body varying between an upper position and a lower position;
an upper spring seat on the vehicle body;
a lower spring seat provided on the arm member so as to oppose the upper spring seat, inclination thereof with respect to the upper spring seat varying as the arm member moves in the up and down directions; and
the coil spring disposed in a compressed state between the upper spring seat and the lower spring seat.
